(19) United States
(12) Patent Application Publication
(10) Pub. No.: US 2026/0101117 A1
(43) Pub. Date: Apr. 9, 2026

(54) BIONIC EVENT IMAGING SYSTEM AND METHOD THEREOF

(71) Applicant: SUN YAT-SEN UNIVERSITY, Guangdong (CN)

(72) Inventor: Lilin LIU, Guangdong (CN)

(73) Assignee: SUN YAT-SEN UNIVERSITY, Guangdong (CN)

(21) Appl. No.: 19/417,338

(22) Filed: Dec. 12, 2025

Related U.S. Application Data
(63) Continuation of application No. PCT/CN2024/098344, filed on Jun. 11, 2024.

(30) Foreign Application Priority Data
Jun. 12, 2023 (CN) 202310693584.4

(51) Int. Cl. H04N 23/741; H04N 23/71; H04N 23/73; H04N 25/40; H04N 25/47; H04N 25/531; H04N 25/707

(52) U.S. Cl. CPC H04N 23/741; H04N 23/71; H04N 23/73; H04N 25/41; H04N 25/47; H04N 25/531; H04N 25/707

(57) ABSTRACT

A bionic event imaging system, which includes: a lens or lens group for collecting the light from the external environment; a controllable blink module comprising a photomask and a control unit for the closing-opening operation of the photomask; and a dynamic vision sensor for detecting the brightness change of the optical signal incident through the controllable blink module, and triggering an event when the brightness change exceeds a preset threshold. The controllable blink module is used to control blocking or allowing the light of the external environment to enter. The photomask correspondingly covers all or part of the light detection units in the dynamic vision sensor at the maximum closed state. The event processing unit, for decoding the event stream generated by the dynamic vision sensor, and reconstructing the absolute light intensity images of static scenes and dynamic scenes in the external environment.

### CROSS-REFERENCE TO RELATED APPLICATION

This application is a continuation of International Application No. PCT/CN2024/098344, filed on Jun. 11, 2024, which claims priority to Chinese Patent Application No. 202310693584.4, filed on Jun. 12, 2023. The disclosures of the aforementioned applications are hereby incorporated by reference in their entireties.

### TECHNICAL FIELD

The invention relates to the field of optical imaging and computer vision technology, more specifically, to a bionic event imaging system and method.

### BACKGROUND

Biological vision system is driven by events in the vision field. Dynamic vision sensor (DVS), also known as event camera, is an array of asynchronous spatiotemporal sensors inspired by biological vision system. Each pixel in the DVS is an independent dynamic vision sensor unit, which is used to detect the brightness change of each pixel asynchronously. When the brightness change exceeds a certain threshold, an event will be triggered. Each event includes the timestamp (i.e. time information) of the encoded brightness change, pixel position and event polarity. Therefore, compared with the frame based standard camera, the event camera has the advantages such as high dynamic range, low latency, low power consumption and so on. In some challenging scenes for traditional frame based cameras, it can unleash more efficient performance. According to the working principle of DVS, the triggering of events can usually occur in the scene with corresponding light changes or the movement of objects. However, for static scenes in dynamic scenes or pure static scenes, events will not be triggered in DVS due to no corresponding brightness change, resulting in the loss of static background information or inability to perceive static scenes. In some application scenarios, only the event stream output by the event camera can solve the related problems. However, in many advanced visual tasks, the absolute light intensity information of the scene is often required, but for event cameras of only the DVS, the absolute light intensity image of the scene cannot be output.

To enable event cameras to perceive the entire scene information, a traditional active pixel sensor (APS) has been proposed to be integrated into the internal circuitry of event cameras, allowing them to output absolute luminance images at a constant frame rate. However, adding an APS module inside the event camera increases its pixel size and consequently enlarges the camera chip's area, resulting in inefficient utilization of the photosensitive area of the chip. Moreover, when the APS sensor and DVS sensor operate simultaneously, the transmitting of frame images requires a higher bandwidth compared to that of event streams, thereby increasing the latency of the event camera. Additionally, since all APS elementary sensors within the camera must operate simultaneously to capture each frame, this significantly raises the power consumption of the event camera, which is detrimental to prolonged working. Another proposal is to add an active light source device outside the event camera, which triggers the events of the entire scene through the flickering of the active light source. However, this solution adds peripheral active light source devices, and the operation of active light sources requires significant power consumption. Moreover, when working outdoors, especially under lighting conditions, ordinary active light sources are almost unable to cause changes in the brightness of the scene when projected onto it, thus unable to trigger scene events.

### SUMMARY

The invention provides a bionic event imaging system and method to overcome the defects of low efficiency and high power consumption when the event camera described in the prior art is used to sense the entire scene information.

To solve the above technical problems, the technical solution of the invention is as follows:

A bionic event imaging system, comprising:
a lens or lens group used for collecting light from the external environment;
a controllable blink module comprising a photomask, and a control unit used for an closing operation and/or an opening operation of the photomask; where the controllable blink module is used for controlling entering of the light of the external environment to be blocked or allowed; the closing operation of the photomask comprises a closing process and a closed state; the opening operation of the photomask comprises an opening process and an opened state;
a dynamic vision sensor used for detecting a brightness change of an optical signal incident through the controllable blink module, and triggering an event when the brightness change exceeds a preset threshold; wherein the photomask correspondingly covers all or part of light detection units in the dynamic vision sensor; the event comprises coordinate information and time information of a triggered pixel and polarity information of the event;
an event processing unit used for decoding an event stream generated by the dynamic vision sensor and reconstructing and generating absolute light intensity images of static scenes and dynamic scenes in the external environment.

As a preferred solution, the dynamic vision sensor comprises an array-type asynchronous spatiotemporal event image sensor based on retinal neural mimicry for asynchronously detecting the brightness change at each pixel.

As a preferred solution, the control unit comprises a rate control sub-unit and a frequency control sub-unit; where the rate control sub-unit is used for manually controlling or electrically controlling an implementing rate of the closing process and/or opening process in each closing and/or opening operation of the photomask; for controlling the closing operation or the opening operation of the photomask being implemented at a uniform-speed or a variable-speed; for controlling the photomask to perform a closing operation or an opening operation when the photomask is fully or not fully opened or closed; where the frequency control sub-unit is used for controlling a cycle frequency of the closing operation and/or the opening operation of the photomask at a fixed frequency or variable frequency; and the cycle frequency controlled by the frequency control sub-unit is less than 60 times/second.

As a preferred solution, the photomask comprises at least one layer of light shielding baffle, and adjustments of shielding ratio and/or shielding region of light detection units in the dynamic vision sensor during the closing operation and/or the opening operation of the photomask are realized by using a rolling shutter mode. The light shielding baffle comprises a flexible rolling shutter or a retractable baffle.

As a preferred solution, the photomask comprises array-arranged light-passing elementary units or light-blocking elementary units, and adjustments of shielding ratio and/or shielding region of light detection units in the dynamic vision sensor during the closing operation and/or opening operation of the photomask are realized in a global mode or a rolling shutter mode.

As a preferred solution, the photomask comprises a first photomask layer and a second photomask layer; where the first photomask layer comprises a light shielding baffle, and the second photomask layer comprises a photomask comprising of a light-passing encoding pattern or a light-blocking encoding pattern.

As a preferred solution, the system further comprises a polarizing optical device comprising a coding pattern for acquiring polarized light or biased light. The polarizing optical device is used for acquiring polarization information of the external environment and transmits polarization information acquired to the event processing unit for decoding.

As a preferred solution, the system further comprises a filter optical device comprising a coding pattern for acquiring light of a specific wavelength or light of a plurality of wavelengths. The filter optical device is used for obtaining light information of a specific wavelength of the external environment or light information of a target spectrum of the external environment, and transmit the light information of the specific wavelength of the external environment or the light information of the target spectrum of the external environment to the event processing unit for decoding.

Further, the invention also proposes a bionic event imaging method applying the bionic event imaging system proposed by the invention. Wherein, the method comprises the following steps:

Controlling the closing operation and/or opening operation of the photomask by the control unit according to the target acquisition requirements; wherein:
when the absolute brightness information of the scene is not required to be obtained, the control unit controls the photomask to perform an opening operation and maintain the opened state, and the event processing unit generates an image of the dynamic scene in the external environment; and
when the absolute brightness information of the scene is required to be obtained, the control unit controls the photomask to perform a cyclic closing-opening operation, and the dynamic vision sensor detects the brightness change of the optical signal incident through the controllable blink module and generates an event stream; the event processing unit decodes the event stream generated by the dynamic vision sensor, and reconstructs and generates the absolute light intensity image of the static scene in the external environment.

As a preferred solution, when the absolute brightness information of the scene is required to be obtained, the event processing unit calculates a trigger rate of the event according to the event stream. When the trigger rate of the event presents an increasing trend within a preset time window, the control unit controls a cycle frequency of the closing-opening operation of the photomask to be decreased; When the trigger rate of the event presents a downward trend within a preset time window, the control unit controls the cycle frequency of the closing-opening operation of the photomask to be increased.

Compared with the prior art, the technical solution of the invention has the following beneficial effects: by simulating the blinking process of humans and animals, the invention places the controllable blink module in front of the dynamic vision sensor, and by controlling the closing-opening operation of the controllable blink module, it can realize the collection of the entire scene information. Finally, the absolute light intensity image reconstruction of static and dynamic scenes is completed in the event processing unit by using the generated event stream, which can reduce the complexity and production cost of the event camera, while maintaining the advantages of high dynamic range, low latency and low power consumption of the event camera to the greatest extent. The invention only uses the event streams triggered by the dynamic vision sensor to reconstruct the scenes. The absolute light intensity image reconstructed from the event streams has the advantages such as high imaging quality in high dynamic range scenes, high temporal resolution of reconstructed images, and no motion blur, and so on.

### BRIEF DESCRIPTION OF DRAWINGS

FIG. 1 shows the architecture of the bionic event imaging system.

FIGS. 2A to 2D shows the event streams generated by some static scenes and the reconstructed absolute intensity image.

FIG. 3 is a schematic diagram of the optical path structure of the system with a single-layer photomask.

FIG. 4 is a schematic diagram of the optical path structure of a system with a double-layer photomask.

FIG. 5 is a schematic diagram of the optical path structure of a system equipped with polarizing optical devices.

FIG. 6 is a schematic diagram of the optical path structure of the system equipped with filter optical devices.

FIG. 7 is a flow chart of the bionic event imaging method.

In the drawings: 1—lens or lens group, 2—controllable blink module, 210 photomask, 211 the first photomask layer, 212 the second photomask layer, 220 control unit, 3—dynamic vision sensor, 4—event processing unit.

### DETAILED DESCRIPTION OF EMBODIMENTS

The accompanying drawings are for illustrative purposes only and cannot be construed as a limitation of the present patent.

In order to better illustrate this embodiment, some parts of the drawings may be omitted, zoomed in or zoomed out, which does not represent the size of the actual product.

It is understandable to those skilled in the art that some well-known structures in the drawings and their descriptions may be omitted.

The technical solution of the invention will be further described below in conjunction with the accompanying drawings and the specific embodiments..

### Embodiment 1

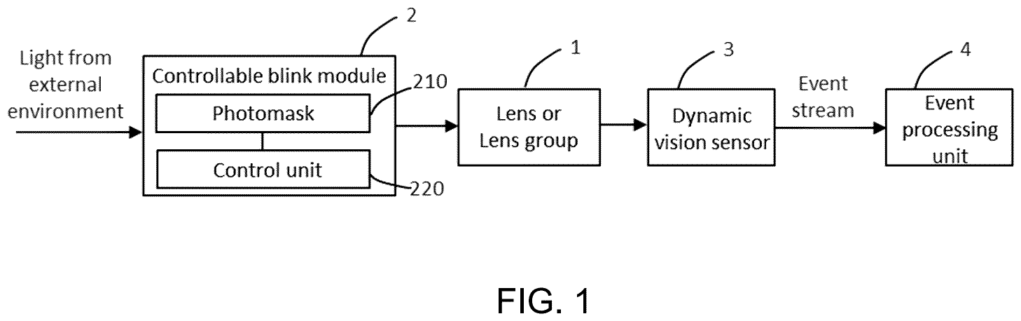

This embodiment proposes a bionic event imaging system, as shown in FIG. 1, which is the architecture of the bionic event imaging system of this embodiment.

The bionic event imaging system proposed in this embodiment includes:
a lens or lens group 1 used for collecting light from the external environment;
a controllable blink module 2 comprising a photomask 210, and a control unit 220 used for an closing operation and/or an opening operation of the photomask 210; where the controllable blink module 2 is used for controlling the entering of the light of the external environment to be blocked or allowed; the closing operation of the photomask 210 comprises a closing process and a closed state; the opening operation of the photomask 210 comprises an opening process and an opened state;
a dynamic vision sensor 3 used for detecting a brightness change of an optical signal incident through the controllable blink module 2, and triggering an event when the brightness change exceeds a preset threshold; where the photomask 210 correspondingly covers all or part of light detection units in the dynamic vision sensor 3; the event comprises coordinate information and time information of a triggered pixel and polarity information of the event;
an event processing unit 4 used for decoding an event stream generated by the dynamic vision sensor 3 and reconstructing absolute light intensity images of static scenes and dynamic scenes in the external environment.

In the specific implementation process, the controllable blink module 2 is optionally arranged at the entrance pupil of the lens or lens group 1, or at the exit pupil of the lens or lens group 1, or in the optical path of the lens group, or in front of the photosensitive window of the dynamic vision sensor 3, or integrated on the photosensitive window surface of the dynamic vision sensor 3.

The dynamic vision sensor 3 is arranged on the rear focal plane of the lens or lens group 1, and the light from the external environment collected by the lens or lens group 1 is incident onto the dynamic vision sensor 3.

The photomask 210 in the controllable blink module 2 implements the closing or opening operation under the control of the control unit 220, thereby blocking the light from the external scene from entering the dynamic vision sensor 3, or allowing the light from the external scene to enter the dynamic vision sensor 3. The dynamic vision sensor 3 detects the brightness change of each pixel through the light detection unit set in its array. When the brightness change exceeds a preset threshold, an event is triggered. The triggered event includes the coordinate information, time information of the triggered pixel and the polarity information of the event. The event streams containing dynamic and static scene information in the external environment are generated and transmitted to the event processing unit 4. The event processing unit 4 performs corresponding storage, decoding, calculation and other processings on the event streams jointly generated by the dynamic vision sensor 3 and the controllable blink module 2, and reconstructs absolute light intensity images of static scenes and dynamic scenes in the external environment.

In this embodiment, by simulating the eye's blinking process of humans and animals, the controllable blink module is placed in front of the dynamic vision sensor 3. By controlling the closing-opening operation of the controllable blink module 2, the entire scene information can be detected. Finally, in event processing unit 4, the generated event stream is used to reconstruct the absolute light intensity image of static and dynamic scenes. Compared with the technology of adding APS sensor on the camera sensor chip, this embodiment can reduce the complexity and production cost of the chip, while maintaining the advantages of high dynamic range, low latency and low power consumption of the event camera to the greatest extent. And compared with the technology of acquiring scene information by adding the flicker of active light source around the event camera, it avoids the greater power consumption requirements and structural complexity brought by the introduction of active light source equipment, especially the problem of severely limited work performances in outdoor strong light or complex lighting scenarios.

In addition, the bionic event imaging system of this embodiment only uses the event stream triggered by the dynamic vision sensor 3 to reconstruct the image, and the absolute light intensity image reconstructed from the event stream has the advantages such as high imaging quality in high dynamic range scenes, high temporal resolution of the reconstructed image, no motion blur, and so on.

It should be noted that, according to the working principle of the event camera, the event represents the brightness change, and each pixel independently encodes the brightness change of the local position of the scene by generating an event. Therefore, the “absolute” brightness can be reconstructed by pixel-wise integrating events. In this embodiment, an exponential decay integration function is adopted.

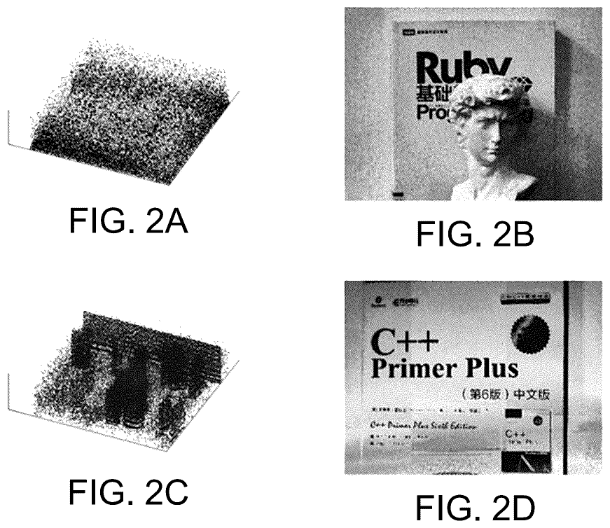

As an example, FIG. 2A to FIG. 2D shows the event stream generated from some static scenes and the reconstructed absolute intensity image. FIG. 2A shows the event stream generated from the static scene in response to the closing-opening operation of the controllable blink module 2 using the roller shutter mode, and its time window is 2 ms; FIG. 2B shows the absolute intensity image reconstructed from the event stream shown in FIG. 2A. FIG. 2C shows another event stream generated from the static scene in response to the closing-opening operation of the controllable blink module 2 using the shutter mode, and its time window is 2 ms; FIG. 2D shows the absolute intensity image reconstructed from the event stream shown in FIG. 2C.

Further, in an optional embodiment, the control unit 220 includes a rate control sub-unit and a frequency control sub-unit.

The rate control sub-unit is used to manually or electrically control the implementing rate of the closing process and opening process in the closing-opening operation of the photomask 210, and to control the closing operation or opening operation of the photomask 210 at a constant speed or a variable speed, that is, to control the blinking speed. The rate control sub-unit is further used to control the photomask 210 to perform a closing operation or an opening operation when it is fully or not fully opened or closed.

During working, the photomask 210 is used to receive information when photomask 210 is in an opened state; when the photomask 210 is in a closed state, the system is in a state of no information reception.

Optionally, this embodiment sets the total time in the opened state to be greater than twice the total time in the closed state to ensure the effective acquisition of external environment information.

The frequency control sub-unit is used to control the cycle frequency of the closing operation and/or opening operation of the photomask 210 at a fixed frequency or variable frequency, that is, to control the blink frequency.

Optionally, the cycle frequency controlled by the frequency control sub-unit is less than 60 times/second; for example, the cycle frequency is around 3-30 times per minute, that is, the 3-30 times of the closing operation and/or opening operation of the photomask 210 is uniformly or non-uniformly distributed within a time window of 1 minute.

It should be noted that the control unit 220 in this embodiment is optionally integrated in the dynamic vision sensor 3 or arranged outside the dynamic vision sensor 3, but the control circuit of the control unit 220 is independent of the circuit of the dynamic vision sensor 3, and the two do not need to be synchronized.

Further, in an optional embodiment, the photomask 210 includes at least one layer of light shielding baffle, and the adjustments of shielding ratio and/or shielding region of light detection units in the dynamic vision sensor during the closing operation and/or the opening operation of the photomask 210 are realized by the rolling shutter mode. The light shielding baffle comprises a flexible rolling shutter or a retractable baffle.

In another optional embodiment, the photomask 210 comprises array-arranged light-passing elementary units or light-blocking elementary units, and the filling rate is 100%. The photomask 210 adopts a global mode or a rolling shutter mode to adjust the opened and closed state of the photomask 210.

As an example, the present embodiment adopts the rolling shutter mode to realize the adjustment of shielding ratio and/or shielding region of light detection units in the dynamic vision sensor during the closing operation and/or the opening operation of the photomask 210.

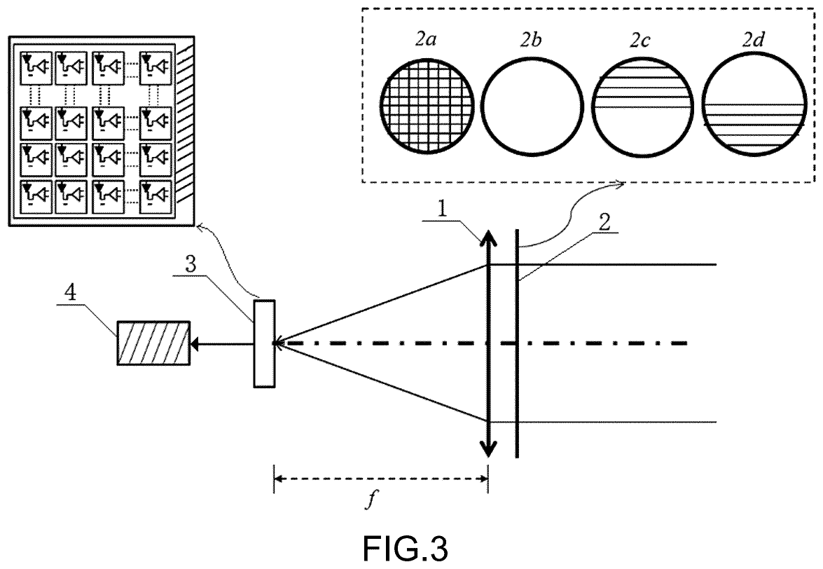

As an example, FIG. 3 shows a schematic diagram of the optical path structure of a system with a single-layer photomask 210. The photomask 210 takes a single-layer structure, which can cover all or part of the optical detection unit of the dynamic vision sensor 3. Its structure is shown in FIG. 3, being labeled as 2a, 2b, 2c and 2d. The structure labeled 2a represents a photomask structure of a light shielding baffle composed of an array of light-passing/light-blocking elementary units with a 100% filling ratio and can cover the whole pupil of the imaging system at the maximum closed state of the photomask 210; the structure labeled 2b presents a photomask structure using a uniform light shielding baffle and can cover the whole pupil of the imaging system at the maximum closed state of the photomask 210; the structure labeled 2c presents a photomask structure that the light shielding baffle only can cover the upper part or the upper half pupil of the imaging system at the maximum closed state of the photomask 210; the structure labeled 2d presents a photomask structure that the shading baffle only can cover the lower part of the lower half pupil of the imaging system at the maximum closed state of the photomask 210. It is noted, when the pupil of the imaging system is covered at different ratio, correspondingly the shielding ratio and/or shielding region of light detection units in the dynamic vision sensor during the closing operation and/or the opening operation of the photomask 210 are adjusted.

When the photomask 210 is performing closing operation line by line or stripe by stripe until arriving at a closed state, the photomask 210 will gradually change from partial occlusion to complete isolation of light from the external scene to incident on the dynamic vision sensor 3. When the photomask 210 is performing opening operation line by line or stripe by stripe until arriving at the open state, the light from the external scene will change from incident on a portion of the light detection units to all light detection units of the dynamic visual sensor 3.

In another optional embodiment, the photomask 210 comprises a first photomask layer 211 and a second photomask layer 212; where the first photomask layer 211 is a light shielding baffle, and the second photomask layer 212 comprises a photomask comprising a light-passing encoding pattern or a light-blocking encoding pattern.

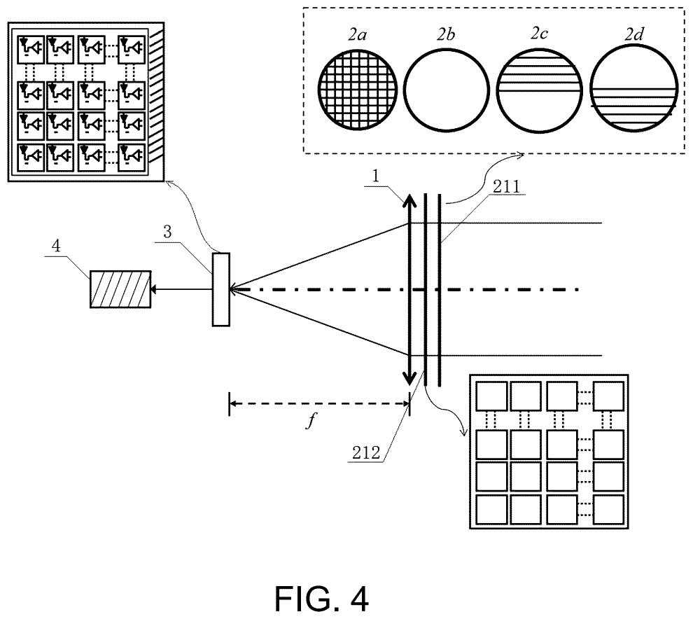

As an example, FIG. 4 shows a schematic diagram of the optical path structure of a system with a double-layer photomask 210. The first photomask layer 211 is a single-layer light shielding baffle, and cyclic operation frequency of closing and opening of the first photomask layer 211 within any time interval is set to be less than 60 times per second. The second photomask layer 212 is a photomask comprising a light-passing coding pattern or a light-blocking coding pattern, arranged to corresponding to the light detection units of the dynamic vision sensor 3. The second photomask layer 212 works at the opened state of the first photomask layer 211.

It should be noted that the coding pattern in the second photomask layer 212 in this embodiment can be a fixed coding pattern or a programming-controlled coding pattern.

The structure of photomask 210 arranged in this embodiment can adopt the corresponding structure of photomask 210 according to different application scenarios or tasks. In addition, the blink and compressed sensing random coding functions can be realized through the photomask 210 to further reduce the data redundancy.

### Embodiment 2

This embodiment is improved on the basis of the bionic event imaging system proposed in embodiment 1.

The bionic event imaging system proposed in this embodiment includes:
a lens or lens group 1 used for collecting light from the external environment;
a controllable blink module 2 comprising a photomask 210, and a control unit 220 used for an closing operation and/or an opening operation of the photomask 210; where the controllable blink module 2 is used for controlling the entering of the light of the external environment to be blocked or allowed; the closing operation of the photomask 210 comprises a closing process and a closed state; the opening operation of the photomask 210 comprises an opening process and an opened state;
a dynamic vision sensor 3 used for detecting a brightness change of an optical signal incident through the controllable blink module 2, and triggering an event when the brightness change exceeds a preset threshold; where the photomask 210 correspondingly covers all or part of light detection units in the dynamic vision sensor 3; the event comprises coordinate information and time information of a triggered pixel and polarity information of the event;
an event processing unit 4 used for decoding an event stream generated by the dynamic vision sensor 3 and reconstructing absolute light intensity images of static scenes and dynamic scenes in the external environment.

Further, in an optional embodiment, the dynamic vision sensor 3 includes an array type asynchronous spatiotemporal event image sensor based on retinal neural mimicry, which is used to asynchronously detect the brightness change of each pixel, and trigger an event when the brightness change exceeds a preset threshold.

In an optional embodiment, the system further includes a polarizing optical device 5, which has a coding pattern for acquiring polarized light or biased light. The polarization optical device 5 is used to acquire the polarization information of the external environment and transmit the polarization information acquired to the event processing unit 4 for decoding.

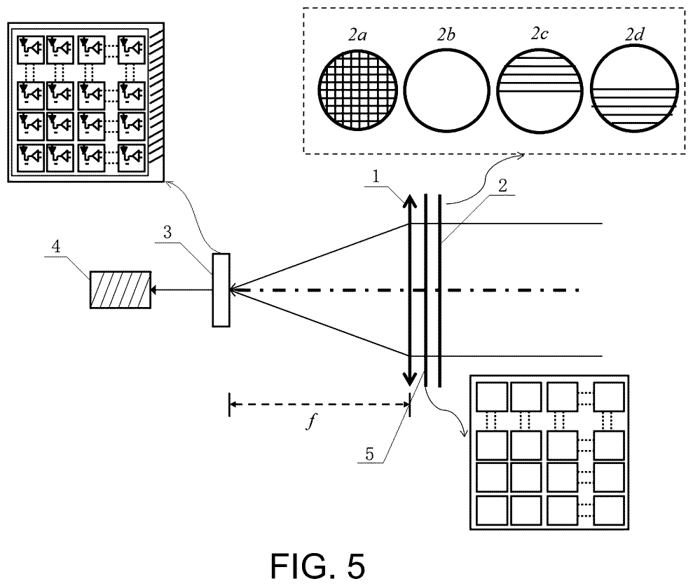

As an example, FIG. 5 shows a schematic diagram of the optical path structure of a system with a polarizing optical device 5. The polarizing optical device 5 has a coding pattern for acquiring polarized light or biased light, and the pattern is arranged to be corresponding to the pixel array of the light detection unit in the dynamic vision sensor 3 pixel by pixel or pixel-group by pixel-group.

The polarizing optical device 5 is optionally arranged at the entrance or exit pupil of the optical lens or lens group 1, or on the surface of the dynamic vision sensor 3 or integrated on the photosensitive window surface of the dynamic vision sensor 3, so as to obtain the polarization information of the external environment.

The polarized light coding pattern of the polarizing optical device 5 of this embodiment can be combined with the pattern coding of the light-passing elementary unit or the light-blocking elementary unit in the controllable blink module 2, and the polarization characteristics are used to realize the physical gating of the light-passing or the light-blocking.

In an optional embodiment, the system further includes a filter optical device 6, which has a coding pattern for acquiring light of a specific wavelength or light of multiple wavelengths. The filter optical device 6 is used to obtain light information of a specific wavelength of the external environment or light information of a target spectrum of the external environment, and transmit the light information of the specific wavelength of the external environment or the light information of the target spectrum of the external environment to the event processing unit 4 for calculation.

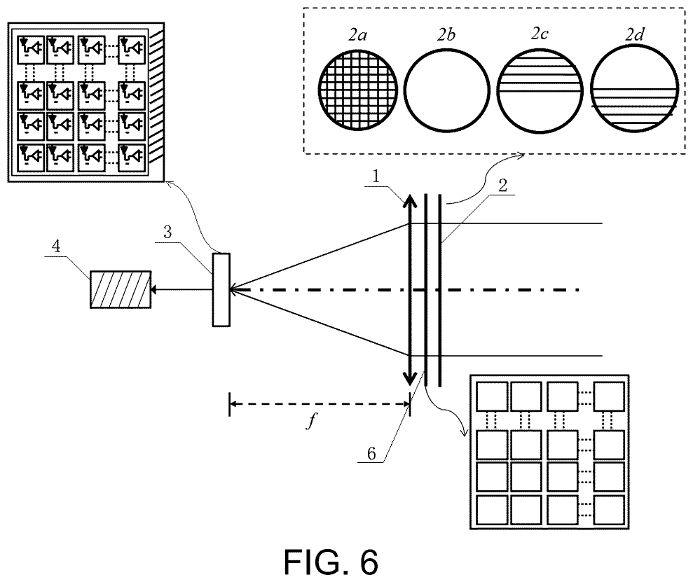

As an example, FIG. 6 shows a schematic diagram of the optical path structure of the system with the filter optical device 6. The filter optical device 6 has a coding pattern for acquiring light of a specific wavelength or light of multiple wavelengths, and the pattern is arranged to be corresponding to the pixel array of the light detection unit in the dynamic vision sensor 3 pixel by pixel or pixel-group by pixel-group.

The filter optical device 6 is optionally placed at the entrance or exit pupil of the optical lens or lens group 1, or optionally placed in front of the photosensitive window of the dynamic vision sensor 3 or integrated on the photosensitive window surface of the dynamic vision sensor 3, so as to acquire the light information of the specific wavelength of the external environment or the light information of the target spectrum of the external environment.

### Embodiment 3

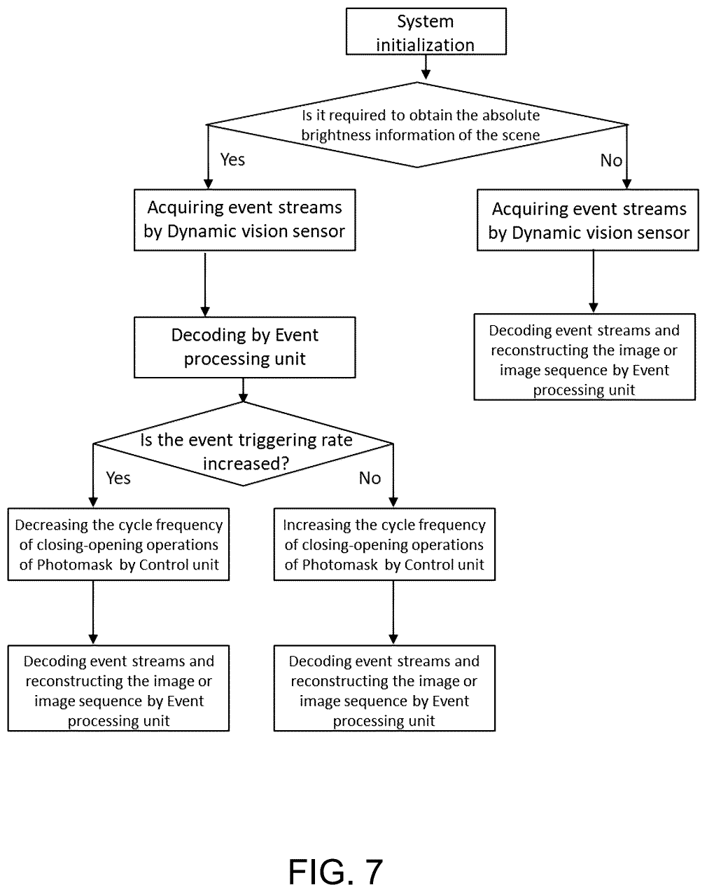

This embodiment proposes a biomimetic event imaging method, which applies to the biomimetic event imaging system proposed in embodiment 1 or embodiment 2. FIG. 7 shows the flowchart of the biomimetic event imaging method in this embodiment.

The biomimetic event imaging method proposed in this embodiment includes the following steps:
controlling the closing operation and/or opening operation of the photomask 210 by the control unit 220 according to target acquisition requirements; wherein:
when the absolute brightness information of the scene is not required to be obtained, the control unit 220 controls the photomask 210 to perform an opening operation and maintain the opened state, and the event processing unit 4 generates an image of the dynamic scene in the external environment; and
when absolute brightness information of the scene is required to be obtained, the control unit 220 controls the photomask 210 to perform a cyclic closing-opening operation, and the dynamic vision sensor 3 detects the brightness change of the optical signal incident through the controllable blink module 2 and generates an event stream; the event processing unit 4 decodes the event stream generated by the dynamic vision sensor 3, and reconstructs the absolute light intensity image of the static scene in the external environment.

In the specific implementation process, the system first initializes by turning on the controllable blink module 2 and enabling the dynamic visual sensor 3. When it is required to obtain the absolute intensity image of the entire scene, the controllable blink module 2 performs one closing-opening operation or performs cyclic closing-opening operations, and then decodes the event stream generated by this process in the event processing unit 4. When it is not required to obtain the absolute intensity image of the entire scene, the generated event stream is directly decoded in the event processing unit 4.

Furthermore, in an optional embodiment, when obtaining absolute brightness information of the scene, the event processing unit 4 calculates the triggering rate of the event based on the event stream. When the triggering rate of the event shows an increasing trend within a preset time window, the control unit 220 controls the frequency of the closing-opening operation of the photomask 210 to be decreased; When the triggering rate of the event shows a decreasing trend within the preset time window, the control unit 220 controls the closing-opening operation frequency of the photomask 210 to be increased.

When it is required to obtain absolute brightness information of the scene, the control unit 220 controls the photomask 210 to perform a cyclic closing-opening operation, and the dynamic visual sensor 3 detects the brightness change of the light signal incident through the controllable blink module 2 and generates an event stream; The event processing unit 4 decodes the event stream within the preset time window and judges whether the event volume increases significantly. If so, it indicates that moving objects occupy the main body of the scene. Under this situation, the control unit 220 controls the frequency of the closing-opening operation of the photomask 210 to be decreased, and the event processing unit 4 decodes the generated event stream into an image or an image sequence; If not, it indicates that static objects occupy the main body in the scene. Under this situation, the control unit 220 controls the cycle frequency of the closing-opening operation of the photomask 210 to be increased, and the event processing unit 4 decodes the generated event stream into an image or an image sequence. Thus, adaptive acquisition of absolute light intensity information image of the entire scene is achieved.

The same or similar reference numerals correspond to the same or similar components.

The terms used to describe the positional relationship in the accompanying drawings is for illustrative purposes only and should not be construed as limiting the scope of this patent.

Obviously, the above embodiments of the present invention are only examples provided to clearly illustrate the present invention, and are not limitations on the embodiments of the present invention. For those skilled in the art, other forms of changes or modifications can be made based on the above explanation. It is not necessary and impossible to exhaustively list all implementation methods here. Any modifications, equivalent substitutions, and improvements made within the spirit and principles of the present invention shall be included within the scope of protection of the claims of the present invention.

What is claimed is:

1. A bionic event imaging system, comprising:
a lens or lens group used for collecting light from external environment;
a controllable blink module comprising a photomask, and a control unit used for an closing operation and/or an opening operation of the photomask; wherein the controllable blink module is used for controlling entering of the light of the external environment to be blocked or allowed; the closing operation of the photomask comprises a closing process and a closed state; the opening operation of the photomask comprises an opening process and an opened state;
a dynamic vision sensor used for detecting a brightness change of an optical signal incident through the controllable blink module, and triggering an event when the brightness change exceeds a preset threshold; wherein the photomask correspondingly covers all or part of light detection units in the dynamic vision sensor; the event comprises coordinate information and time information of a triggered pixel and polarity information of the event;
an event processing unit used for decoding an event stream generated by the dynamic vision sensor and reconstructing and generating absolute light intensity images of static scenes and dynamic scenes in the external environment.

2. The bionic event imaging system according to claim 1, wherein the dynamic vision sensor comprises an array-type asynchronous spatiotemporal event image sensor based on retinal neural mimicry for asynchronously detecting the brightness change at each pixel.

3. The bionic event imaging system according to claim 1, wherein the control unit comprises a rate control sub-unit and a frequency control sub-unit;
wherein the rate control sub-unit is used for manually controlling or electrically controlling an implementing rate of the closing process and/or opening process in each closing and/or opening operation of the photomask; for controlling the closing operation or the opening operation of the photomask being implemented at a uniform-speed or a variable-speed; for controlling the photomask to perform a closing operation or an opening operation when the photomask is fully or not fully opened or closed;
wherein the frequency control sub-unit is used for controlling a cycle frequency of the closing operation and/or the opening operation of the photomask at a fixed frequency or variable frequency; and the cycle frequency controlled by the frequency control sub-unit is less than 60 times/second.

4. The bionic event imaging system according to claim 1, wherein the photomask comprises at least one layer of light shielding baffle, and adjustments of shielding ratio and/or shielding region of light detection units in the dynamic vision sensor during the closing operation and/or the opening operation of the photomask are realized by using a rolling shutter mode; the light shielding baffle comprises a flexible rolling shutter or a retractable baffle.

5. The bionic event imaging system according to claim 1, wherein the photomask comprises array-arranged light-passing elementary units or light-blocking elementary units, and adjustments of shielding ratio and/or shielding region of light detection units in the dynamic vision sensor during the closing operation and/or opening operation of the photomask are realized by using a global mode or a rolling shutter mode.

6. The bionic event imaging system according to claim 1, wherein the photomask comprises a first photomask layer and a second photomask layer; wherein the first photomask layer comprises a light shielding baffle, and the second photomask layer comprises a photomask comprising a light-passing encoding pattern or a light-blocking encoding pattern.

7. The bionic event imaging system according to claim 1, wherein the system further comprises a polarizing optical device comprising a coding pattern for acquiring polarized light or biased light; the polarization optical device is used for acquiring polarization information of the external environment and transmit polarization information acquired to the event processing unit for decoding.

8. The bionic event imaging system according to claim 1, wherein the system further comprises a filter optical device comprising a coding pattern for acquiring light of a specific wavelength or light of multiple wavelengths; the filter optical device is used for obtaining light information of a specific wavelength of the external environment or light information of a target spectrum of the external environment, and transmit the light information of the specific wavelength of the external environment or the light information of the target spectrum of the external environment to the event processing unit for decoding.

9. A bionic event imaging method applying to the bionic event imaging system according to claim 1, comprising:
controlling the closing operation and/or opening operation of the photomask by the control unit according to target acquisition requirements; wherein:
when the absolute brightness information of the scene is not required to be obtained, the control unit controls the photomask to perform an opening operation and maintain the opened state, and the event processing unit generates an image of the dynamic scene in the external environment; and
when absolute brightness information of the scene is required to be obtained, the control unit controls the photomask to perform a cyclic closing-opening operation, and the dynamic vision sensor detects the brightness change of the optical signal incident through the controllable blink module and generates an event stream; the event processing unit decodes the event stream generated by the dynamic vision sensor, and reconstructs the absolute light intensity image of the static scene in the external environment.

10. The bionic event imaging method according to claim 9, wherein when the absolute brightness information of the scene is required to be obtained, the event processing unit calculates a triggering rate of the event according to the event stream, and when the trigger rate of the event presents an increasing trend within a preset time window, the control unit controls a cycle frequency of the closing-opening operation of the photomask to be decreased; when the triggering rate of the event presents a downward trend within a preset time window, the control unit controls the cycle frequency of the closing-opening operation of the photomask to be increased.

11. The bionic event imaging system according to claim 2, wherein the system further comprises a polarizing optical device comprising a coding pattern for acquiring polarized light or biased light; the polarization optical device is used for acquiring polarization information of the external environment and transmit polarization information acquired to the event processing unit for decoding.

12. The bionic event imaging system according to claim 3, wherein the system further comprises a polarizing optical device comprising a coding pattern for acquiring polarized light or biased light; the polarization optical device is used for acquiring polarization information of the external environment and transmit polarization information acquired to the event processing unit for decoding.

13. The bionic event imaging system according to claim 4, wherein the system further comprises a polarizing optical device comprising a coding pattern for acquiring polarized light or biased light; the polarization optical device is used for acquiring polarization information of the external environment and transmit polarization information acquired to the event processing unit for decoding.

14. The bionic event imaging system according to claim 5, wherein the system further comprises a polarizing optical device comprising a coding pattern for acquiring polarized light or biased light; the polarization optical device is used for acquiring polarization information of the external environment and transmit polarization information acquired to the event processing unit for decoding.

15. The bionic event imaging system according to claim 6, wherein the system further comprises a polarizing optical device comprising a coding pattern for acquiring polarized light or biased light; the polarization optical device is used for acquiring polarization information of the external environment and transmit polarization information acquired to the event processing unit for decoding.

16. The bionic event imaging system according to claim 2, wherein the system further comprises a filter optical device comprising a coding pattern for acquiring light of a specific wavelength or light of multiple wavelengths; the filter optical device is used for obtaining light information of a specific wavelength of the external environment or light information of a target spectrum of the external environment, and transmit the light information of the specific wavelength of the external environment or the light information of the target spectrum of the external environment to the event processing unit for decoding.

17. The bionic event imaging system according to claim 3, wherein the system further comprises a filter optical device comprising a coding pattern for acquiring light of a specific wavelength or light of multiple wavelengths; the filter optical device is used for obtaining light information of a specific wavelength of the external environment or light information of a target spectrum of the external environment, and transmit the light information of the specific wavelength of the external environment or the light information of the target spectrum of the external environment to the event processing unit for decoding.

18. The bionic event imaging system according to claim 4, wherein the system further comprises a filter optical device comprising a coding pattern for acquiring light of a specific wavelength or light of multiple wavelengths; the filter optical device is used for obtaining light information of a specific wavelength of the external environment or light information of a target spectrum of the external environment, and transmit the light information of the specific wavelength of the external environment or the light information of the target spectrum of the external environment to the event processing unit for decoding.

19. The bionic event imaging system according to claim 5, wherein the system further comprises a filter optical device comprising a coding pattern for acquiring light of a specific wavelength or light of multiple wavelengths; the filter optical device is used for obtaining light information of a specific wavelength of the external environment or light information of a target spectrum of the external environment, and transmit the light information of the specific wavelength of the external environment or the light information of the target spectrum of the external environment to the event processing unit for decoding.

20. The bionic event imaging system according to claim 6, wherein the system further comprises a filter optical device comprising a coding pattern for acquiring light of a specific wavelength or light of multiple wavelengths; the filter optical device is used for obtaining light information of a specific wavelength of the external environment or light information of a target spectrum of the external environment, and transmit the light information of the specific wavelength of the external environment or the light information of the target spectrum of the external environment to the event processing unit for decoding.
